(19) United States
(12) Patent Application Publication
(10) Pub. No.: US 2004/0145334 A1
(43) Pub. Date: Jul. 29, 2004

(54) Method associated with controlling a synchronous machine

(76) Inventor: Reijo Virtanen, Vantaa (FI)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/476,146

(22) PCT Filed: May 16, 2002
(86) PCT No.: PCT/FI02/00420

(30) Foreign Application Priority Data
May 17, 2001 (FI) 20011050

(51) Int. Cl. H02P 5/28

(52) U.S. Cl. 318/712

(57) ABSTRACT

A method in connection with a synchronous machine, the method comprising the steps of determining phase currents (iᵤ, iᵥ, i_{w}) of a stator in the synchronous machine, determining phase voltages (uᵤ, uᵥ, u_{w}) of a stator in the synchronous machine and estimating a position angle (γ). The method also comprises the steps of generating estimates for stator flux vector components (ψ_{iα}, ψ_{iβ}) of the determined phase currents (iᵤ, iᵥ, i_{w}) of the stator and the estimated rotor angle (γ) using a current model (2) of the synchronous machine, generating estimates for the stator flux vector components (ψ_{iα}, ψ_{iβ}), comparing the generated stator flux vector estimates (ψ_{iα}, ψ_{iβ}; ψ_{α}, ψ_{β}) with the phase difference of the estimates in order to achieve a proportional quantity, and adjusting the estimate (γ) of the rotor position angle on the basis of the quantity proportional to the phase difference.

### BACKGROUND OF THE INVENTION

The invention relates to a method in connection with a synchronous machine, whereby the synchronous machine is provided with control equipment including a current model on the synchronous machine, the method comprising the steps of determining phase currents of a stator in the synchronous machine, determining phase voltages of a stator in the synchronous machine and estimating a position angle of a rotor in the synchronous machine.

Synchronous machines are generally used as motors in the applications thereof, where extensive power is required as well as reliable behaviour at a broad speed range. High-powered synchronous motors are controlled in a controlled manner using cycloconverters or other types of frequency converters, which provide the stator of the synchronous motor with the desired voltage.

In order to control a synchronous machine reliably, the rotor position angle of the synchronous machine should be known as accurately as possible. The position angle is previously typically defined using an apparatus intended to determine the position angle, such as a resolver or a pulse sensor. However, a position angle sensor is a mechanical component that wears when used and that should be mounted and wired appropriately. As regards the use, the position angle sensor is a critical object, since the motor operation becomes unusable if the resolver or pulse sensor belonging thereto is broken or damaged.

The rotor position angle of the synchronous motor can also be determined without a position angle sensor. The determination can be based on a motor model composed of the differential equations of the synchronous machine. Such a motor model obtains as starting information the measurement data concerning the stator currents fed into the motor stator and the rotor magnetization current. In addition, the model requires motor parameters in order to function, such as values of motor resistances and inductances. The motor model is also frequently used for controlling the machine. If the rotor position angle obtained from the motor model is not the correct one, errors are also caused to the flux estimates calculated from the flux equations and used for controlling and adjusting the machine. Owing to the erroneously calculated flux values, the machine cannot be optimally controlled.

When no sensors are used, the errors the motor model causes become a problem. Due to the errors the operation of the motor model does not correspond with the situation in an actual motor. The motor model fluxes in particular do not correspond with the actual motor fluxes owing to the saturation of the actual inductances and the other possibly inaccurate parameter values used in the model. This causes the midpoint of the vector quantities to shift from the actual midpoint thereof and also an erroneous rotor position angle of the model in relation to the actual rotor position angle.

### BRIEF DESCRIPTION OF THE INVENTION

It is an object of the invention to provide a method that avoids the problems mentioned above and enables to control the synchronous machine more reliably than before using the same measurements of the electric quantities as previously. This object is achieved with the method of the invention, characterized in that the method also comprises the steps of generating estimates for stator flux vector components in the synchronous machine of the determined phase currents of the stator in the synchronous machine and the estimated rotor angle using the current model of the synchronous machine, generating estimates for the stator flux vector components in the synchronous machine of the determined phase voltages, comparing the generated stator flux vector estimates with the phase difference of the estimates in order to achieve a proportional quantity, and adjusting the estimate of the rotor position angle on the basis of the quantity proportional to the phase difference.

The invention is based on the idea that determining the stator fluxes of the synchronous machine using different starting information allow comparing said fluxes and thus to obtain a phase-locked system, which is able to find the rotor position angle of the synchronous machine and provides the control with the correct value of the terminal angle.

An advantage with the method of the invention is to achieve the reliability of the quantities describing the electric state of the synchronous machine, whereby the adjustment and control of the machine can reliably be based on the flux values. In addition, the method allows controlling the synchronous machine reliably without a mechanical sensor of the rotational speed.

### BRIEF DESCRIPTION OF THE DRAWINGS

In the following, the method will be described in greater detail by means of the preferred embodiments with reference to the accompanying drawings, in which

FIG. 1 is a block diagram showing a method of the invention.

### DETAILED DESCRIPTION OF THE INVENTION

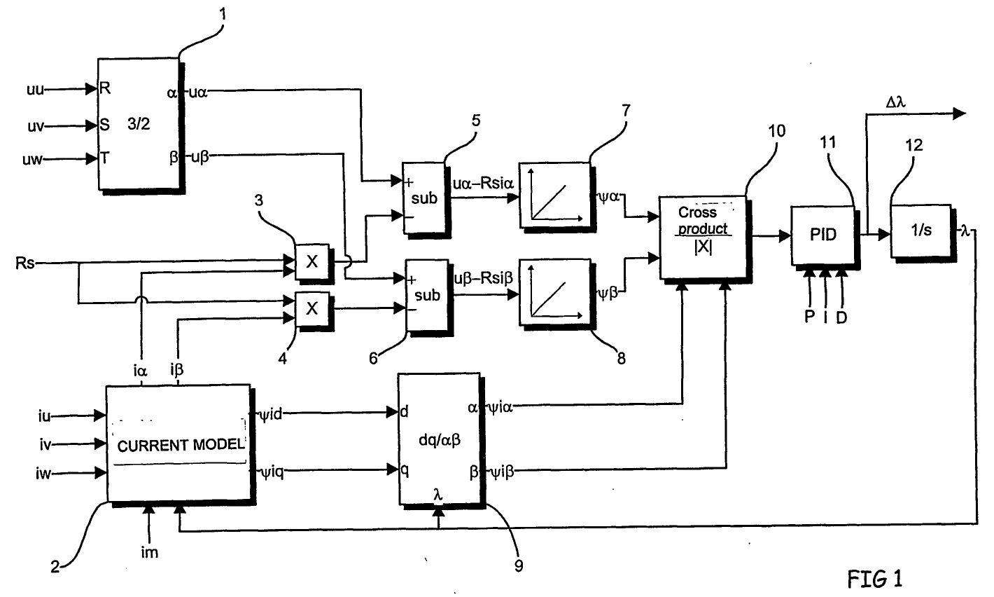

FIG. 1 is a block diagram showing a method of the invention. A synchronous machine is controlled using a control device, such as a cycloconverter or a frequency converter, including power switches. The power switches in the control device provide voltage or current in accordance with the control method to the terminals of the machine stator in order to appropriately control the machine. In accordance with the invention the quantities of the stator currents are measured. Typically synchronous machines comprise a three-phase winding without a neutral conductor, whereby measuring the current of two phases is enough to determine the currents of all three phases.

Furthermore, the voltages fed into the machine stator are determined. The determination of the voltages can be implemented in connection with the control device or by measuring the voltage directly from the terminals of the synchronous machine stator. The measurement data concerning the currents and the voltages is typically required irrespective of how the synchronous machine is controlled or adjusted.

The determined stator voltages uᵤ, uᵥ, u_{w} are converted (1) into component form, whereby the three-phase stator voltage can be presented as a combination of two components u_{α}, u_{β}. Converting an electric quantity such as a voltage into component form signifies in practice that a space vector is formed of the quantity and that rectangular components of the space vector are separated from one another. In other words, for instance the two-axis model components b_{α} and b_{β} of the space vector quantity b can be determined so that component α is the real part of vector b and component β is correspondingly the imaginary part of vector b. Similarly the space vector can be constructed from the two-axis model component b=b_{α}+jb_{β}.

To convert the phase voltages from phase quantities into the two-axis model components α and β can be carried out using the formula shown in matrix form

$$[ \begin{matrix}{u}_{α} \\ {u}_{β} \\ {u}_{0}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} ] [ \begin{matrix}{u}_{u} \\ {u}_{v} \\ {u}_{w}\end{matrix} ] . \qquad ( 1 )$$

The formula (1) also perceives the possible zero component u₀ of the voltage, which is nevertheless not required in the method.

The measurement data concerning the stator currents is fed as shown in FIG. 1 to a current model 2 formed of the synchronous machine. The current model provides as outputs thereof stator currents i_{α} and i_{β} converted into two-component form. Converting the stator currents into two-component form occurs in a similar way as described above in connection with stator voltages. The voltage and current components α and β shown above are presented in stator co-ordinates.

Since a stator resistance Rₛ is known from the parameters of the synchronous machine, the effect of the resistive losses can be reduced from the determined stator voltages. The size of the resistive losses can simply be calculated by multiplying the stator current quantities by the stator resistance Rₛ. These multiplications are carried out in multiplication blocks 3 and 4 in FIG. 1.

Since the stator currents are converted into the same coordinates as the stator voltages, the resistive losses caused by the currents can be reduced from the stator voltages. Such a reduction occurs in the embodiment shown in FIG. 1 in subtraction blocks 5 and 6. As a result of the subtraction the value of the voltage is obtained that provides stator flux to the stator.

The stator flux components provided by the voltage are calculated in accordance with the invention by integrating 7, 8 previously calculated voltages. As is known in the art, the integral expression of the voltage forms a flux, whereby the output of blocks 7 and 8 implements the expression

ψ_{α,β}=∫(u_{α,β}−Rₛi_{α,β})dt. (2)

In block 7 in FIG. 1 the stator flux α component ψ_{α} and correspondingly in block 8 the stator flux β component ψ_{β} are calculated. As mentioned above, a space vector can easily be formed of said quantity from the quantities in component form.

The size of the stator flux calculated as shown above is correct, but as is known in the art it becomes inaccurate for instance because the midpoint of the flux shifts or owing to an error occurring on the integral for computational reasons. Since the flux is used as is known in the art for controlling the machine, the flux value should be corrected to be as accurate as possible in order to ensure a reliable control. In order to correct the midpoint of the flux, the restriction of the amplitude of the voltage integral or another method can for instance be employed with cycloconverters.

As mentioned previously, a current model 2 on the synchronous machine is prepared. The current model allows determining the electric state of the synchronous machine as accurately as possible using the determined current values as starting information. The model prepared on the synchronous machine includes parameter values of the inductances and resistances of the machine. The model is drawn up to describe the state of the synchronous machine in static and dynamic states. Several inductance values of the synchronous machine strongly depend on the rotor angle λ in relation to the stator, whereby the current model prepared on the machine requires the information about the rotor's position angle.

The measurement data concerning the stator currents are conveyed into the current model in accordance with the invention and the estimates of the machine's stator fluxes ψ_{id} and ψ_{iq} are obtained as the current model outputs. FIG. 1 shows how the flux values to be obtained from the current model are presented in synchronous dq co-ordinates, i.e. a co-ordinate system that rotates attached to the rotor of the synchronous machine. In such a case the flux estimates are equal quantities, and are therefore simple to use for instance for controlling the machine.

As shown in FIG. 1, the flux estimates ψ_{id} and ψ_{iq} shown in the dq co-ordinates are converted into the stator co-ordinates using a conversion block 9. In order to convert the co-ordinates, information or an estimate concerning the angle between the co-ordinates is required, or in this case the rotor position λ in relation to the stator. Even though the conversion block 9 of the co-ordinates is shown as a block separated from the current model 2, the conversion can be carried out as included in the current model, since the current model obtains the same value or estimate from the position angle between the stator and the rotor. The stator flux estimates ψ_{iα}, ψ_{iβ} drawn up from the current model are obtained as outputs of the co-ordinates of the conversion block 9.

After the conversion 9 of the co-ordinates is carried out, the stator flux ψ_{α}, ψ_{β} calculated on the basis of the voltage integral and the stator flux ψ_{iα}, ψ_{iβ} obtained on the basis of the current model are in the same coordinates, wherefore these fluxes should correspond to one another. Fluxes determined in accordance with the invention and particularly the phases thereof are compared with one another. Calculating the cross product between the fluxes preferably compares the phases. The stator fluxes shown in vector form are the following: ψₛ=ψ_{α}+jψ_{β} and ψₛᵢ=ψ_{iα}+jψ_{iβ}, whereby the expression of the cross product is simply ψₛ×ψₛᵢ=ψ_{α}ψ_{iβ}−ψ_{β}ψ_{iα}. The cross product between two vectors describes the angle difference between the vectors, or in this case the phase difference of stator flux vectors calculated in different ways. If the result of the cross product operation is zero, the vectors are precisely parallel, which is the desired result.

The result of the cross product between the stator fluxes is fed in accordance with the invention into the input of a controller 11. The controller 11 is typically a normal PID controller, whose parameter values can be determined appropriately.

The output of the controller 11 is integrated using an integrator 12, whereby the integrator output λ is used as an estimate for the rotor position angle. The estimate concerned is fed into the current model 2 and the conversion element 9 of the co-ordinates as shown in FIG. 1 in accordance with the invention. The output of the controller 11 affects the output of the cross product element 10 through the current model 2 and the conversion element 9, and tends to zero said output, in which case the stator fluxes calculated on the basis of the current model and the voltage integral are co-phasal.

Since the position angle is the integral of the angular speed, an estimate is obtained from the output of the controller 11 for the rotors angular speed Δλ. The angular speed can be utilized for instance for control purposes in other connections.

A system like the one described implements the phase-locked system using the provided cross product, the controller and the angle estimate λ to be used for feedback. The size of the flux obtained using the voltage integral is precisely accurate, but the exact direction of the rotor axis is not known until the rotor angle is estimated in the method of the invention and the synchronous machine can be controlled reliably for example on the basis of the fluxes.

It should be noted that the above description describes the implementation and operation of the method on the basis of quantities in component form for the sake of simplicity. However, it is apparent that the component form is one way to present the vector quantity and therefore the invention is fully realizable even by means of directly vector formed quantities.

It is obvious for those skilled in the art that as technology advances the basic idea of the invention can be implemented in various ways. The invention and the embodiments thereof are therefore not restricted to the above examples but can be modified within the scope of the claims.

1. A method in connection with a position angle sensorless and a rotational speed sensorless control of a synchronous machine, whereby the synchronous machine is provided with control equipment including a current model on the synchronous machine, the method comprising the steps of
determining phase currents (iᵤ, iᵥ, i_{w}) of a stator in the synchronous machine,
determining phase voltages (uᵤ, uᵥ, u_{w}) of a stator in the synchronous machine, and
estimating a position angle (λ) of a rotor in the synchronous machine, characterized in that the method also comprises the steps of
generating estimates for stator flux vector components (ψ_{iα}, ψ_{iβ}) in the synchronous machine from the determined phase currents (iᵤ, iᵥ, i_{w}) of the stator in the synchronous machine and the estimated rotor angle (λ) using the current model (2) of the synchronous machine,
generating estimates for the stator flux vector components (ψ_{iα}, ψ_{iβ}) in the synchronous machine from the determined phase voltages (uᵤ, uᵥ, u_{w}),
comparing the generated stator flux vector estimates (ψ_{iα}, ψ_{iβ}; ψ_{α}, ψ_{β}) in order to achieve a quantity proportional to the phase difference of the estimates, and
adjusting the estimate (λ) of the rotor position angle on the basis of the quantity proportional to the phase difference.

2. A method as claimed in claim 1, characterized in that the comparison of the generated stator flux vector estimates (ψ_{iα}, ψ_{iβ}; ψ_{α}, ψ_{β}) comprises a step, in which a cross product between said estimates is formed in order to achieve a quantity proportional to the phase difference of the estimates.

3. A method as claimed in claim 1 or 2, characterized in that the generation of the stator flux vector component estimates (ψ_{iα}, ψ_{iβ}) comprises a step, in which the estimates (ψ_{iα}, ψ_{iβ}) are generated of the determined phase voltages (uᵤ, uᵥ, u_{w}) using integration.

4. A method as claimed in claim 1, 2 or 3, characterized in that the generation of the stator flux vector component estimates (ψ_{iα}, ψ_{iβ}) of the determined phase voltages (uᵤ, uᵥ, u_{w}) comprises a step, in which the resistive losses of the stator are reduced from the determined phase voltages before generating the estimates.

5. A method as claimed in any one of preceding claims 1 to 4, characterized in that the method further comprises the steps of
conducting a proportional quantity to the phase difference of the stator flux vector estimates to the PID controller in order to obtain an estimate (Δλ) of the position angle change, and
integrating the position angle change estimate (Δλ) in order to obtain an estimate (λ) of the rotor position angle.
